(19) United States
(12) Patent Application Publication
(10) Pub. No.: US 2026/0097282 A1
(43) Pub. Date: Apr. 9, 2026

(54) System and Method for Testing a Sports Paddle

(71) Applicant: Sweet Spot Testing, LLC, Steamboat Springs, CO (US)

(72) Inventor: David M. Lorenzen, Steamboat Springs, CO (US)

(73) Assignee: Sweet Spot Testing, LLC, Steamboat Springs, CO (US)

(21) Appl. No.: 19/328,677

(22) Filed: Sep. 15, 2025

Related U.S. Application Data
(60) Provisional application No. 63/704,754, filed on Oct. 8, 2024.

(51) Int. Cl. A63B 60/42; A63B 24/00; A63B 102/08; G01M 99/00

(52) U.S. Cl. CPC A63B 60/42; A63B 24/0021; G01M 99/008; A63B 2024/0034; A63B 2102/08; A63B 2220/806; A63B 2220/807; A63B 2220/89; A63B 2225/50

(57) ABSTRACT

A system for evaluating a sports paddle. The sports paddle has a handle and a playing surface. Preferably, the sports paddle is a pickleball paddle. The system includes a platform, and a securing mechanism for holding a sports paddle onto the platform. The securing mechanism may be, for example, a clamp. The system also includes a ball release mechanism. The ball release mechanism is configured to release a ball onto the playing surface of the paddle at a selected coordinate on the playing surface. The ball release mechanism may be an elongated tube having an upper opening and a lower opening. The system further comprises a ball detection device configured to record a path of the ball upon release from the ball release mechanism. Methods of testing sports paddles is also provided herein.

### CROSS-REFERENCE TO RELATED APPLICATIONS

This application claims the benefit of U.S. Ser. No. 63/704,754 filed Oct. 8, 2024. That application is entitled “System and Method for Testing a Sports Paddle” and is incorporated herein in its entirety by reference.

### STATEMENT REGARDING FEDERALLY SPONSORED RESEARCH OR DEVELOPMENT

Not applicable.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light and not necessarily as admissions of prior art.

### FIELD OF THE INVENTION

The present disclosure relates to the field of racquet sports. More specifically, the present invention relates to pickleball paddles. The present disclosure further relates to a device for testing surface response of a sports paddle, such as a pickleball paddle, in a uniform or standardized manner. The present disclosure also relates to the generation of histograms or graphics representing the responsiveness of a pickleball paddle upon being struck by a ball for analysis of the response across the face of the paddle.

### TECHNOLOGY IN THE FIELD OF THE INVENTION

Pickleball is a racquet sport that was invented in the State of Washington in the 1960's. Pickleball was developed as an alternative to tennis, which is a difficult sport to master. The game of pickleball offers a net that is lower than a tennis net, a court that is smaller than a tennis court, a paddle that is smaller than a tennis racquet, and a ball that is lighter and moves more slowly than a tennis ball. The perceived benefit of pickleball over tennis is that it is easier to learn than tennis (primarily since the ball moves more slowly through the air and bounces along a lower trajectory), requires little running (particularly for doubles), yet still offers players the experience of a racquet sport that requires good footwork, quick reflexes, and an understanding of angles on a court.

The sport of pickleball has grown rapidly over the last ten years. Many racquet clubs and public parks have added pickleball courts and programs to their facilities. The USA Pickleball Association (or “USAPA”) has been formed as a governing body in the United States. Internationally, the International Federation of Pickleball (or “IFP”) serves as a governing body for international competition. Together, the USAPA and the IFP publish a rules book.

Unlike a tennis racquet, a pickleball paddle does not employ a string bed; rather, it offers a solid hitting surface similar to a ping pong paddle. According to Section 2.E.2 of the rules, the paddle's hitting surface “shall not contain holes, cracks, rough texturing, or indentations that break the paddle skin or surface, or any objects or features that allow a player to impart excessive spin on the ball.” This is a marked departure from tennis which uses the string bed to impart different degrees of spin, depending on how the string is manufactured, the combination of main and cross-strings used, the tension of the strings, and how the ball is struck.

According to the rules of pickleball, paddle roughness is determined using a Starrett SR160 Surface Roughness Tester (or equivalent). “The allowable limits for roughness shall be no greater than 30 micrometers (μm) on the Rz reading (average maximum height, peak to valley) and no greater than 40 micrometers on the Rt reading (average maximum height, peak to valley).” All readings will be taken in six different directions.

In addition, there are size limitations to the pickleball paddle. According to Section 2.E.3, “[t]he combined length and width, including any edge guard and butt cap [of the paddle], shall not exceed 24 inches (60.96 cm). The paddle length cannot exceed 17 inches (43.18 cm).” The rules do permit some variation in length to width ratio, and there is no restriction on paddle thickness. The most common shape for a paddle is a “wide-body” that measures approximately 8 inches wide by 15¾ inches long (20.32 cm×40 cm).

Recent changes to the USAPA rules allow players to add an edge guard such as tape. However, the rules inhibit the player from generating artificial spin through the modification of the paddle surface. Here is a list of prohibited features:
Anti-skid paint or any paint textured with sand, rubber particles, or any material that causes additional spin.
Rubber and synthetic rubber.
Sandpaper characteristics.
Moving parts that can increase head momentum.

Despite these restrictions, the manufacturers of pickleball paddles market their different products as having more power, more control, or balanced power and control. This is typically done by providing different core materials below the outer surface, or skin, of the paddles.

According to the USAPA website, over 2,500 different paddles have been approved since the organization's inception. Over 900 new paddles were submitted for approval by over 400 manufacturers in 2023 alone. Many of these paddles offer distinctive profiles and color combinations as part of their branding.

Manufacturers use one of several core materials in their paddles. These include fiberglass, aluminum, polymer (typically polypropylene), and synthetic fibers (such as Nomex® available from DuPont Safety & Construction, Inc. of Delaware).

Most paddles today utilize a core formed in a honeycomb pattern. This is believed to provide a combination of strength and stability. When the core is fabricated from a polymer, the cells in the honeycomb pattern will be larger when compared to cores fabricated from other, alternative materials. Polymer cores are said to provide more feel, more touch, and a quieter response to the ball. As an alternative, the core may be fabricated from aluminum or Nomex™. Aluminum and Nomex® are touted as offering increased power and durability. In any instance, the core is fabricated from a continuous material.

Concerning the facing, pickleball paddles will typically use one of three materials—fiberglass, graphite, or carbon fiber. Fiberglass is common and is said to offer control, or feel. Graphite and carbon fiber are stronger and more durable, and are believed to provide power, or “pop.”

FIG. 1A is a plan view of an illustrative sports paddle 100. In this view, a front face of the paddle 100 is seen. The paddle 100 is used to play the sport of pickleball. This is one of several paddles available from Selkirk Sport, LLC located in Coeur D'Alene, Idaho. This particular paddle 100 is sold under the SLK™ trademark. (Note that the surface graphics have been removed from the drawing.)

FIG. 1B is a perspective view of the Selkirk® paddle 100. Features of the paddle 100 will be described with reference to FIGS. 1A and 1B together.

The paddle 100 has a first end 102 and a second opposing end 104. The first end 102 is located at a handle 110 of the paddle 100. The handle 110 is configured and dimensioned to be used by a player in holding the paddle 100. A synthetic or polymeric grip may be wrapped around the handle 110 to provide stability and comfort for the player.

The second end 104 is located at a so-called head 130 of the paddle 100. The head 130 defines a flat playing surface 132 on each side of the head 130. The playing surfaces 132 are configured to strike a ball (not shown) during a game of pickleball.

Intermediate the handle 110 and the playing surfaces 132 is a transition section 120. The transition section connects the handle 110 with the wider head 130. The head 130 and the transition section 120 are bounded by a so-called head guard 135, which may also be referred to herein as an “edge guard.” In all known pickleball paddles, the head guard 135 is fabricated from a pliable polymeric material. The head guard 135 protects the core material making up the head 130.

The SLK™ paddle 100 is said to have a polymer core, which is increasingly common among pickleball paddle manufacturers. The face is described by the manufacturer as a textured composite material. This paddle 100 presents a standard wide body profile.

FIG. 2A is a plan view of an illustrative sports paddle 200 in a second arrangement. This paddle 200 is also distributed by Selkirk Sport, LLC. FIG. 2B is a perspective view of the paddle 200 of FIG. 2A. (Note again that surface graphics have been removed as being irrelevant to the current filing.) The paddle 200 will be discussed with reference to FIGS. 2A and 2B together.

The paddle 200 includes a first end 202 and a second opposing end 204, with the first end 202 being located at a handle 210 of the paddle 200 and the second end 204 being located at a head 230. As with head 130, the head 230 defines a flat playing surface 232 on each side of the head 230. The playing surfaces 232 are configured to strike a ball (not shown) during a game of pickleball.

Intermediate the handle 210 and the playing surfaces 232 is a transition section 220. The transition section connects the handle 210 with the wider head 230. A head guard 235 is again provided to protect the core material within the head 230.

Paddle 200 differs from paddle 100 primarily in the presentation of the head 230. In the head 230, a through-opening 225 is provided along the transition section 220. The concept of an open throat paddle was first developed in 2020 by Kitchen Pro LLC.

It is believed that most paddle distributors are not actually manufacturing their own paddles; rather, they are just paying another company to produce a previously-designed paddle under a so-called OEM contract. In other words, they are simply choosing an existing paddle style and providing the graphics for the factory to produce a paddle for them.

Most paddles are manufactured by one of only a few domestic companies. Those include Selkirk (from Idaho), Engage (from Florida), Paddletek® (from Michigan), Diadem (from Florida), and Players® (from Washington). A few companies design and prototype their own paddles, but then contract out with third party factories for production. Examples include Gearbox (from California), Legacy® (from North Carolina), SixZero® (from Australia), and Joola (from Germany). In any event, any company with a new paddle brand can submit the paddle to the USAPA, regardless of the specifications, pay the nominal $1,500 USD fee (recently increased to $2,000 USD), and obtain approval for distribution and sale.

With the proliferation of paddles, a need exists for a testing device that can generate an objective value for the response of a ball upon being struck by the paddle. A need further exists for a device that can record and quantify a series of ball strikes, and present them as a histogram for visualization and analysis. Still further, a need exists for a system that operates with a mobile computing device such as an iPads or an iPhone® serving as an optical feedback and analytical system.

### BRIEF SUMMARY OF THE INVENTION

Systems and methods for evaluating a sports paddle are provided herein. Preferably, the sports paddle is a pickleball paddle. The pickleball paddle has a handle and a playing surface.

In one aspect of the present disclosure, a testing system comprises a platform. The platform is used to support the handle of the paddle during testing. In one aspect, the platform comprises a sliding x-y frame supported on a table or on a dedicated stand.

The system also includes a securing mechanism. The securing mechanism is used to hold the sports paddle on the platform in a stationary manner. The securing mechanism may be, for example, one clamp or a pair of clamps. Of importance, a playing surface of the paddle is held in a precisely horizontal position by the clamps.

The system also comprises a ball release mechanism. The ball release mechanism is configured to release a ball onto the playing surface at a selected coordinate on the playing surface. The ball release mechanism may be, for example, a tube positioned in a precisely vertical orientation over the playing surface. Because the playing surface is horizontal, the ball will rebound in an absolutely vertical direction for consistent testing, assuming both the paddle and the ball are geometrically perfect and free of localized surface imperfections. It is to be understood that a vertically released, perfectly spherical ball will rebound strictly vertically; any ball out-of-roundness, paddle surface irregularity, or departure from vertical release will introduce unwanted, lateral components to the rebound of the ball.

The testing system further includes a ball detection device. The ball detection device is configured to record a path of the ball upon release from the ball release mechanism. In one aspect, a top (or apex) height of the rebound of the ball is recorded in memory using a computing device. As paddle testing is performed at different locations on the playing surface, the computing system records the heights of a series of ball rebounds in memory as tracked by the camera. Thus, data is recorded that associates the coordinate at which the ball strikes the paddle with the height of the ball.

In another aspect, a laser gun or a radar gun (Doppler effect) is utilized as a ball detection device. In this instance, the ball detection device is measuring the speed of the ball (i) as it approaches the hitting surface of the paddle, (ii) as it leaves the hitting surface of the paddle, or (iii) both. As paddle testing is performed at different locations on the playing surface, the computing system records the speeds of a series of ball rebounds in memory as tracked by the ball detection device. Data is recorded that associates the coordinates at which the ball strikes the paddle with the rebound speed of the ball.

The computing system may be programmed to convert the data into a histogram. The histogram may present data in a two-dimensional form, or it may present data in a three-dimensional form. In either instance, the histogram demonstrates a responsiveness of a particular paddle under a standardized condition.

Testing may be conducted on a number of different paddles for comparison. This data may be presented to a manufacturer for analysis of its paddles, and optionally, for comparison of its own paddle performances as against paddles of other manufacturers. In one aspect, data from the testing of a large number of paddles is placed into a digital catalog and then made available through a subscription model. Preferably, software enables each histogram to be rotated so that different three-dimensional views can be seen.

In another aspect, the collection of histograms is made available to players so that they can see the performance of their selected paddle. This may be done through a subscription model, or through a “pay-to-play” service such as at a tournament or a pickleball facility. From this data, players may then choose to demonstrate and/or purchase another paddle having a more preferred responsiveness or other characteristic(s).

In an alternate arrangement, the ball release mechanism is designed to shoot, or fire, a pickleball at the playing surface of the paddle. In this instance, the ball release mechanism may be a compressed air launcher or an elastic band-loaded mechanism. In this arrangement, the playing surface of the paddle need not be placed in a horizontal orientation. The high-speed camera measures the speed of the pickleball both before and after impact. Measurements may be taken at different locations along the playing surface in order to generate the histogram. This may be done by moving the ball release mechanism relative to the paddle, or by moving the paddle relative to the ball release mechanism.

### DESCRIPTION OF THE DRAWINGS

So that the manner in which the present disclosures can be better understood, certain illustrations, charts, and/or flow charts are appended hereto. It is to be noted, however, that the drawings illustrate only selected embodiments of the present disclosures and are therefore not to be considered limiting of scope, for the disclosure may admit to other equally effective embodiments and applications.

FIG. 1A is a plan view of a known sports paddle. The illustrative paddle is used for playing the sport of pickleball.

FIG. 1B is a perspective view of the pickleball paddle of FIG. 1A.

FIG. 2A is another plan view of a known sports paddle. Again, the illustrative paddle is used for playing the sport of pickleball.

FIG. 2B is a perspective view of the pickleball paddle of FIG. 2A.

FIG. 3 is an enlarged view of a third sports paddle. Here, representative “x” and “y” coordinates are superimposed over the paddle.

FIG. 4A is a perspective view of a system used for testing a response of a ball upon impact with a sports paddle of the present invention, in a first embodiment.

FIG. 4B is a perspective view of a system used for testing a response of a ball upon impact with a sports paddle of the present invention, in a second embodiment. In this arrangement, the paddle is held securely by means of a sliding, x-y frame.

FIG. 5A is an enlarged view of the testing system of FIG. 4A or 4B, showing the sports paddle fixed in horizontal orientation for testing.

FIG. 5B is a first enlarged view of the testing system of FIG. 5A. Here, a pickleball is visible against a measuring apparatus.

FIG. 5C is second enlarged view of the testing system of FIG. 5A. Here, the measuring apparatus is shown resting on the playing surface of the paddle.

FIG. 5D is an enlarged view of the testing system of FIG. 4B. Here, the paddle and the measuring apparatus are seen from above the playing surface.

FIG. 6A is a first computer-generated view of a histogram showing the response of a ball relative to a pickleball paddle.

FIG. 6B is a second computer-generated view. This is another view of the histogram of FIG. 6A, wherein a 3-D plot of the histogram has been rotated.

FIG. 7A is a perspective view of a clamp (or positioning device) as may be used to secure a handle of a sports paddle for testing of the paddle. In this view, the clamp is in an open, or first, position.

FIG. 7B is a perspective view of the clamp (or positioning device) of FIG. 7A.

In this view, the clamp is in a closed, or second, position.

FIG. 8 presents a perspective view of a camera (or optical system) as may be used for capturing images for the testing system of FIGS. 4A and 4B. In this arrangement, the camera and a so-called flash are separate components.

FIG. 9 is a representative x-y frame as may be used to secure the positioning device of FIG. 5.

FIGS. 10A and 10B present a single flow chart showing steps for performing a method of testing response of a ball off of a sports paddle, in one embodiment.

FIG. 11 is a schematic diagram of a computing system that can be used to implement the method of testing response of a ball off of a sports paddle according to exemplary embodiments of the present disclosure.

FIG. 12 is a perspective view of an x-y laser level that is used to see where on the paddle the dropped ball will hit.

FIG. 13A is a computer-generated view of a histogram showing the response of a ball relative to a pickleball paddle, in an alternate embodiment. In this view, the histogram shows 3-D data.

FIG. 13B is a histogram wherein the responsiveness of a plurality of paddles is shown together, In this view, the histogram shows 2-D data.

### DETAILED DESCRIPTION OF SELECTED SPECIFIC EMBODIMENTS

Novel features characteristic of embodiments provided in the present application are set forth in the appended claims. However, the embodiments themselves and further objectives and advantages thereof, will best be understood by reference to the following detailed description when read in conjunction with the accompanying figures, wherein:

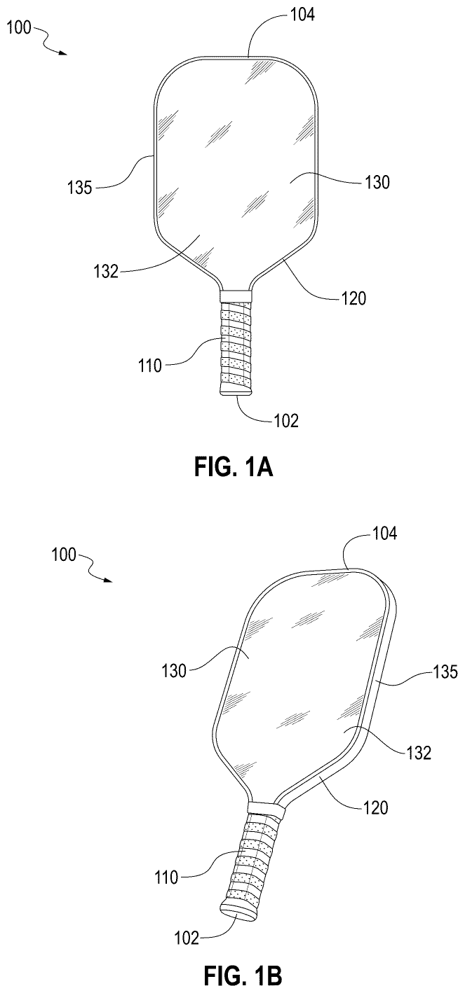

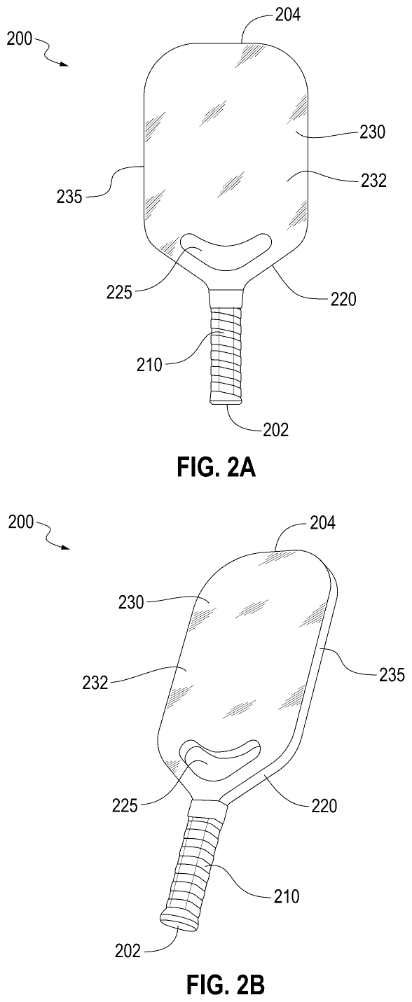

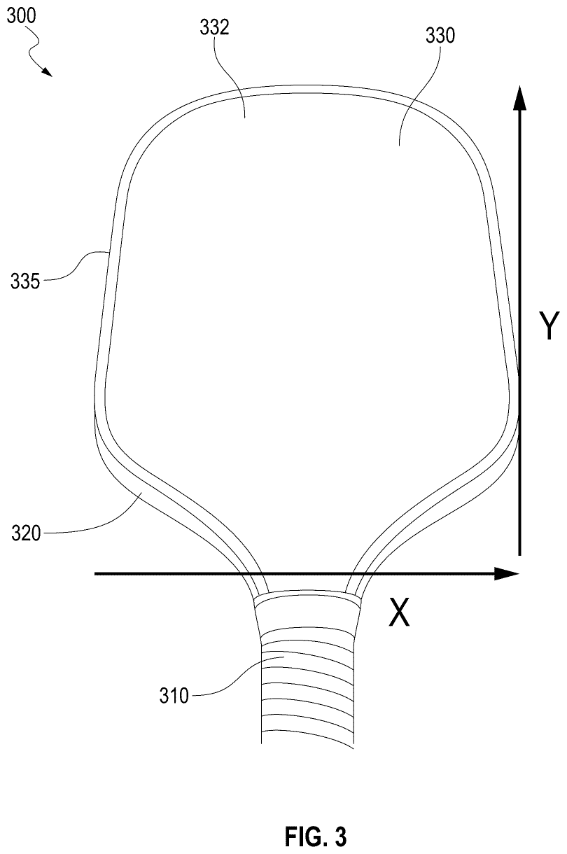

FIG. 3 is an enlarged view of a sports paddle 300. The paddle 300 functions like the paddle 100 in FIGS. 1A and 1B. In this respect, paddle 300 also includes a handle 310, a transition section 320, and a head 330. A head guard 335 is provided to protect the head 330.

In FIG. 3, it can be seen that “x” and “y” coordinates are shown adjacent to the paddle 300. This enables the head 330 of the paddle 300 to be partitioned into identifiable “x” and “y” locations according to the Cartesian coordinate system. In one aspect, a center-line of the head 330 represents a value of “0” along the “x” coordinate. Points along the head 330 that are left of the center-line will have a negative value, while points along the head 330 that are to the right of the center-line will have a positive value.

A center of the paddle's playing surface 332 can be defined as x=0 and y=0 (0, 0). x is defined as a distance from the center of the paddle 300 parallel to the handle 310. Positive x is defined as extending to the right when the paddle 300 is positioned horizontally with the handle 310 oriented toward an observer. y is defined as a distance from the handle 310 perpendicular to the handle 310. Negative y is close to the handle 310, whereas Positive y is farther away from the handle 310.

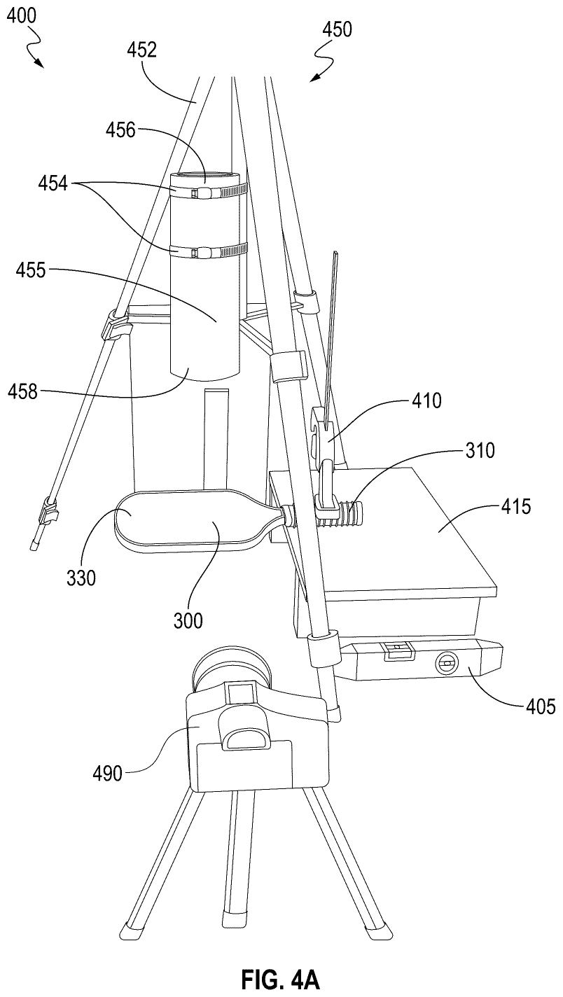

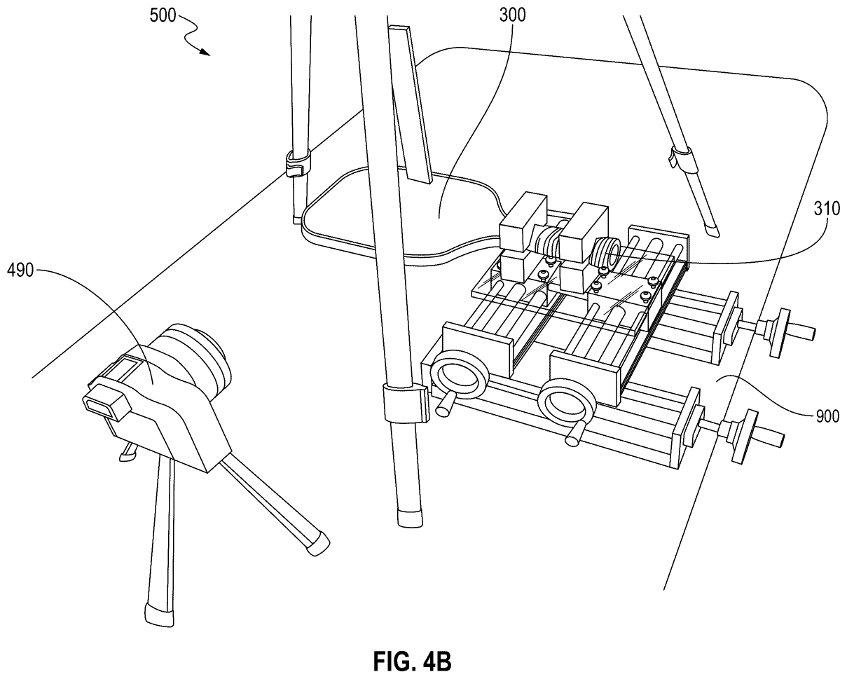

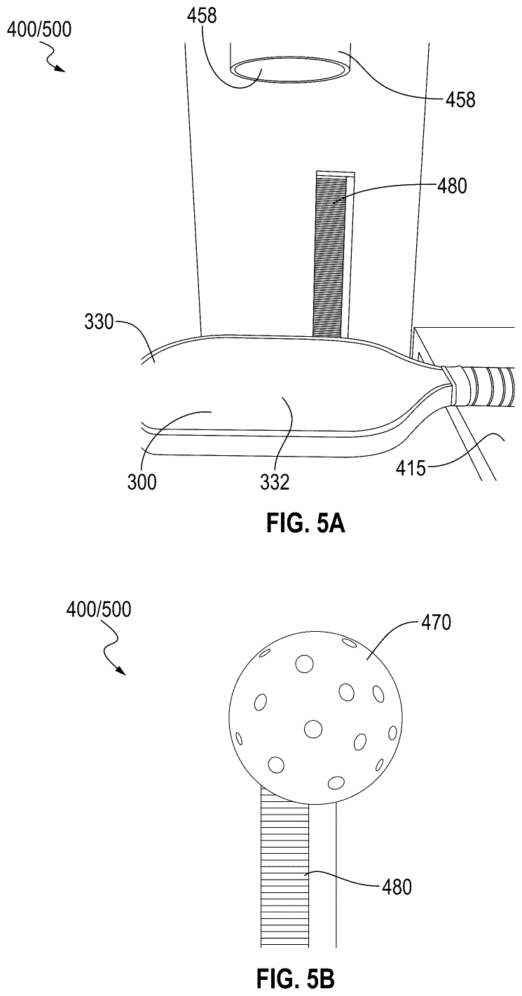

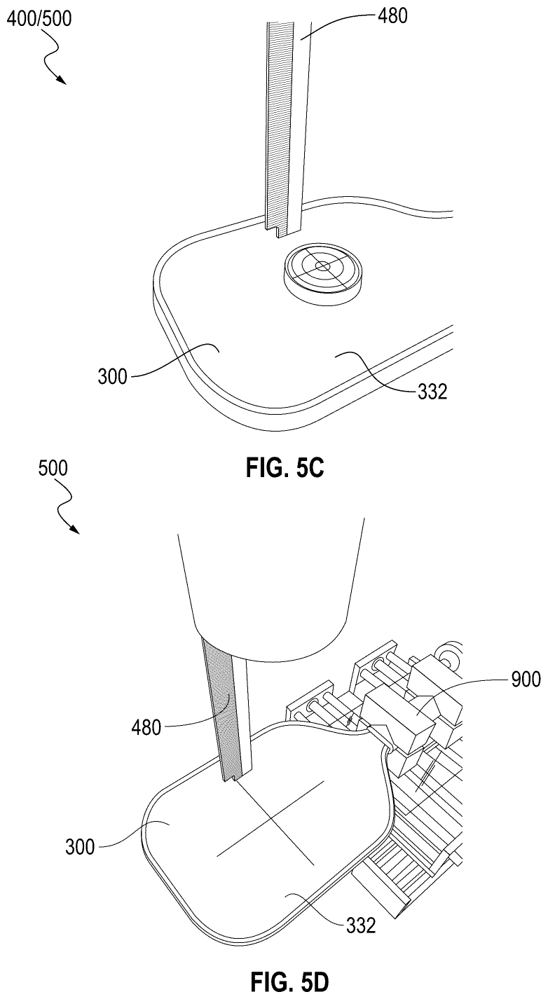

FIG. 4A is a perspective view of a system 400 used for evaluating a response of a ball (shown at 470 in FIG. 5B) upon impact with a sports paddle, in a first embodiment. The sports paddle 300 of FIG. 3 is shown in position for testing.

The system 400 first comprises a clamp 410. The clamp 410, which may be referred to alternatively herein as the paddle's securing mechanism, is secured to a platform 415. The platform 415 defines a horizontal surface that receives both the clamp 410 and the handle 310 of the paddle 300 such that the paddle 300 is held in a stationary position. Of importance, the head 330 of the paddle 300 is positioned in a perfectly horizontal orientation.

A level 405 is shown in FIG. 4A. The level 405 may be used to ensure that the platform 415 and the head 330 of the paddle 300 are level. Measurements of the head 330 may be taken in both the “x” and the “y” directions to ensure that the head 330 is horizontal at all coordinates.

The testing system 400 also includes a launch mechanism 450. The launch mechanism 450 is designed to ensure that the ball, such as ball 470 of FIG. 5B, is launched from a consistent height, and falls in a perfectly vertical direction. The illustrative launch mechanism 450 includes a stand 452. In the arrangement of FIG. 4A, the stand 452 is a tri-pod.

The launch mechanism 450 also has a release tube 455. The release tube 455 is secured to the stand 452 to ensure consistency in testing. In the arrangement of FIG. 4A, two circular clamps 454 are used to secure the release tube 455 to the stand 452. The level 405 may be used to ensure that the release tube 455 is secured to the stand 452 in a perfectly vertical manner, that is, along a “z” plane.

The release tube 455 has an upper opening 456 and a lower opening 458. The release tube 455 allows the ball 470 to be positioned just above the upper opening 456, then released, allowing the ball 470 to fall through the lower opening 458 and onto the head 330 of the paddle 300. Preferably, the release tube 455 has an inner diameter that is slightly larger than a diameter of the ball, such as ball 470 of FIG. 5B, being dropped during testing.

A position of the release tube 455 relative to the paddle 300 is important. The upper opening 456 is positioned at a predetermined height above the playing surface 332 of the head 330. In one aspect, this height is 22 inches (55.9 cm). At the same time, the lower opening 458 should be high enough above the playing surface 332 to allow for measurement of the response of the ball 470 after it contacts and rebounds off the playing surface 332.

During testing, the ball 470 is manually released into the upper opening 456 of the release tube 455. The ball 470 then falls gravitationally through the tube 455, through the lower opening 458, and onto the playing surface 332 (sometimes referred to as a “blade”). Since the height from the paddle's blade 332 to the upper opening 456 of the tube 455 is a fixed distance, the ball 470 will have a repeatable speed when it impacts the blade 332.

Either the tube clamps 454 or the paddle's mounting mechanism 410 can be moved so that the dropped ball 470 can strike the playing surface 332 in any location, i.e., any coordinate. It is believed to be easier to move the stand 452 (and connected release tube 455) than to move the paddle 300. However, this is an operator's choice.

FIG. 4B is a perspective view of a system 500 used for testing a response of a ball upon impact with a sports paddle of the present invention, in a second embodiment. In this arrangement, the paddle 300 is held securely by means of a sliding, x-y frame 900. Us of the allows the operator to easily and accurately adjust a position of the blade 332 under the release tube 455 without moving the tri-pod 452.

FIG. 5A is an enlarged view of the testing system 400 of FIG. 4A or testing system 500 of FIG. 4B. For ease of reference and with regard to FIGS. 5A through 5D, testing system 400 and testing system 500 will be referred to collectively as testing systems 400, 500, as differences in the mounting or securing of the paddle 300 are not material to the present figures. Here, the sports paddle 300 is shown extending from the platform 415. The head 330 is in a horizontal orientation and is fixed to the platform 415 for testing.

The lower opening 458 of the release tube 455 is also visible. The lower opening 458 is positioned above the head 330 in such a way that the ball 470 can be dropped onto the paddle 300, striking the playing surface 332 at a pre-set coordinate.

A ruler 480 is shown in FIG. 5A. The ruler 480 is preferably metered in millimeters for precise measurements. Measurement “0” is at the bottom of the ruler 480 and is aligned with the playing surface 332 of the head 330.

Returning to FIGS. 4A and 4B, the testing systems 400, 500 further include a ball detection device 490. The ball detection device 490 is preferably a high-speed camera. The camera 490 is positioned to interact with the ruler 480. As noted, measurement “0” on the ruler 480 is set to the same height as the blade's surface 332. When the ball 470 is dropped through the tube 455, the ball 470 travels downward until it hits the playing surface 332. The ball 470 then bounces off of the playing surface 332 and rebounds upward. Eventually, the ball 470 stops traveling upward (typically within two seconds) and again falls.

FIG. 5B is a first enlarged view of the testing systems 400, 500 of FIG. 5A.

Here, a pickleball 470 is visible. The pickleball 470 is shown against the ruler 480, or “measuring apparatus” 480.

FIG. 5C is a second enlarged view of the testing systems 400, 500 of FIG. 5A. Here, the measuring apparatus 480 is shown resting on the playing surface 332 of the paddle 300.

FIG. 5D is an enlarged view of the testing system 500 of FIG. 4B. Here, the paddle 300 and the measuring apparatus 480 are seen from above the playing surface 332. In this view, the paddle 300 is held in its horizontal orientation by the sliding x-y frame 900. Notice placement of x-y coordinates on the playing surface 332.

In operation, the high-speed camera 490 is set to start recording when the ball 470 first comes into view as it exits the release tube 455 via the lower opening 458. After the ball 470 bounces off of the paddle's playing surface 332, the ball 470 blocks the bottom of the ruler 480 from the camera's 490 sight. As the ball 470 rises, the ruler's 480 marks can be seen below the bottom of the ball 470. The rebounded height of the ball 470 can be determined by pausing the video when the ball 470 is at its apex) and looking at a corresponding mark on the ruler 480.

In an alternative arrangement, the ball detection device 490 is configured to measure the speed of the ball before and after impact. This allows the operator, or the software, to compare how a paddle surface responds to balls that are hit at different locations on the playing surface 332. In one aspect, the operator launches balls at the paddle with a compressed air launcher at previously selected speeds. Alternatively, a spring-biased mechanism, a servo-actuated arm, or an elastic band-biasing mechanism may be used to fire a pickleball. Alternatively still, a rotational wheel launcher such as is described in U.S. Pat. No. 7,980,967 (“Programmable Ball Throwing Apparatus”) is employed.

In any event, a ball impacting the face 332 at a greater velocity will better measure the response of the honeycomb structure behind the facing. Thus, a compressed air launcher may be more effective than merely dropping the ball under force of gravity. Optionally, the operator can adjust the firing speed of a ball release mechanism to test responsiveness of the paddle. It is understood that speed of the ball following impact and height of the rebound following impact are both measurements of paddle responsiveness. For purposes of the present disclosure, the terms “response” or “responsiveness” encompass both measurements of height and measurements of speed.

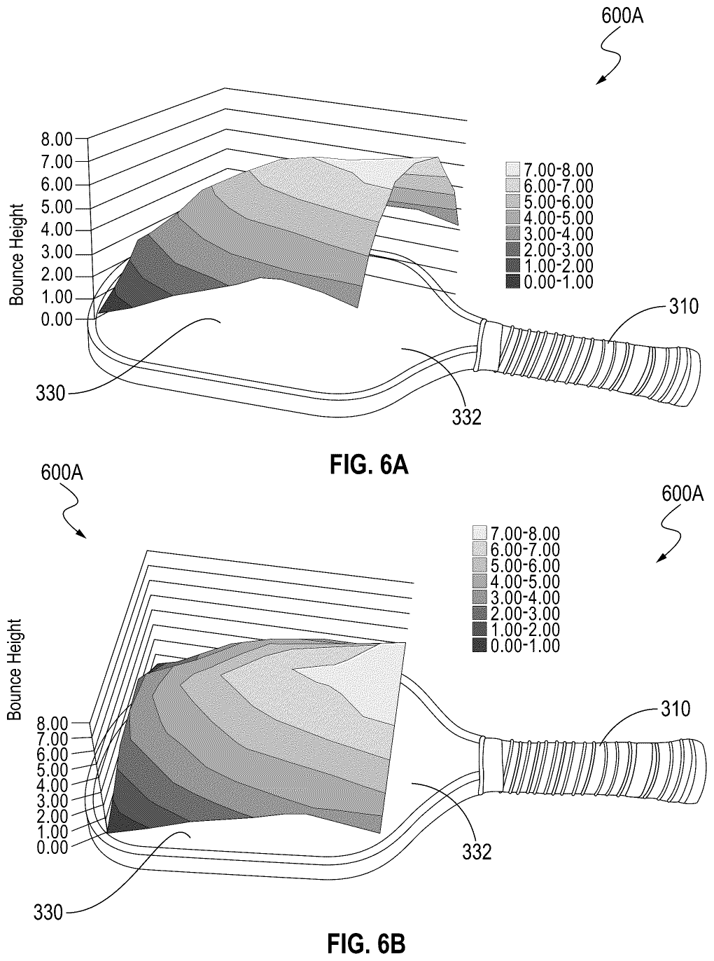

FIG. 6A is a first computer-generated view of a histogram 600A showing the response of a ball, such as ball 470, relative to a pickleball paddle, such as paddle 300. In this illustrative example, the paddle 300 is a Joola® Hyperion Pro Series. The paddle 300 includes a handle 310 and a playing surface 332. The branding has been removed from the illustration.

The histogram 600A demonstrates the response of the ball 470 after being dropped onto different locations of the paddle's playing surface 332. In this context, responsiveness means the height of the ball as it rebounds off of the playing surface 332. To generate the histogram 600A, the ball 470 was dropped numerous times from its fixed height, e.g., 22 inches, onto the pickleball paddle 300. Before every drop, the paddle 300 was moved horizontally so that the ball 470 impacted the paddle's surface 332 on a specific grid pattern, i.e., x-y coordinate. The resulting rebound bounce height from each location was logged and a 3-D plot was generated from the data using software.

It can be seen that the paddle 300 produces a strong reflection near, and on the center-line, of the handle 310. The reflection becomes increasingly weak as the ball 470 hits farther away from the handle 310. Similarly, the ball response becomes increasingly weaker as its strike point moves away from the center-line (both Positive x and Negative x) formed off of the handle 310.

It can be seen from the 3-D plot that the ball 470 will bounce almost 8 inches if it hits the center of the x-axis close to the handle 310. This might be referred to as coordinate (0, −3). If the ball 470 hits the paddle's playing surface 332 in the center at coordinate (0, 0), it will bounce somewhere between 6 inches (15.2 cm) and 7 inches (17.8 cm) high. If the ball 470 is hit perfectly centered in the “x” axis but 2 inches (5.1 cm) away from the center away from the handle at coordinate (2, 0), the ball 470 will only bounce three inches (7.6 cm) to 4 inches (10.2 cm).

FIG. 6B is a second computer-generated image. FIG. 6B is another view of the histogram 600A of FIG. 6A from a different perspective. The histogram 600A has simply been rotated using software, showing more of a top view.

Of interest, the computer-generated histogram 600A demonstrate a so-called “sweet spot” of the paddle 300. Almost all paddle manufacturers mention or promote a “sweet spot.” Of course, this is not scientifically defined; it just implies an area on the paddle that generates the best response or that produces the least vibration when the ball 470 is struck. Ideally, the so-called sweet spot of the paddle 300 will be anywhere along the center-line of the playing surface 332. Beneficially, and as demonstrated in FIGS. 6A and 6B, using the present systems 400, 500, a true sweet spot can be visualized along the center-line of the paddle 300.

One observation to be made from looking at histogram 600A is that there is no clearly defined “sweet spot.” Stated another way, there is no one coordinate where the response presented by the ball 470 and its rebound is much better than every other coordinate. Perhaps a sweet spot can now be defined as an area where the ball reflects+/−10% over the entire area. With actual scientific data, there is a chance that a sweet spot can be defined.

A more desirable paddle would have a flatter 3-D plot than those shown in histogram 600A.

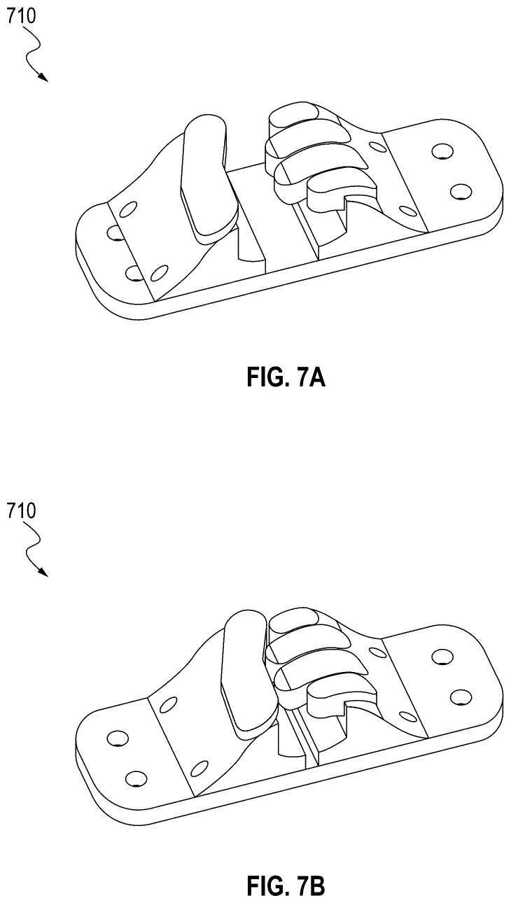

FIG. 7A is a perspective view of a clamp (or positioning device) 710 as may be used to secure a handle of a sports paddle for testing of the paddle. In this view, the clamp 710 is in an open, or first, position.

FIG. 7B is a perspective view of the clamp (or positioning device) 710 of FIG. 7A. In this view, the clamp 710 is in a closed, or second, position. Note that in this arrangement the clamp 710 is designed to mimic a grip offered by a human hand.

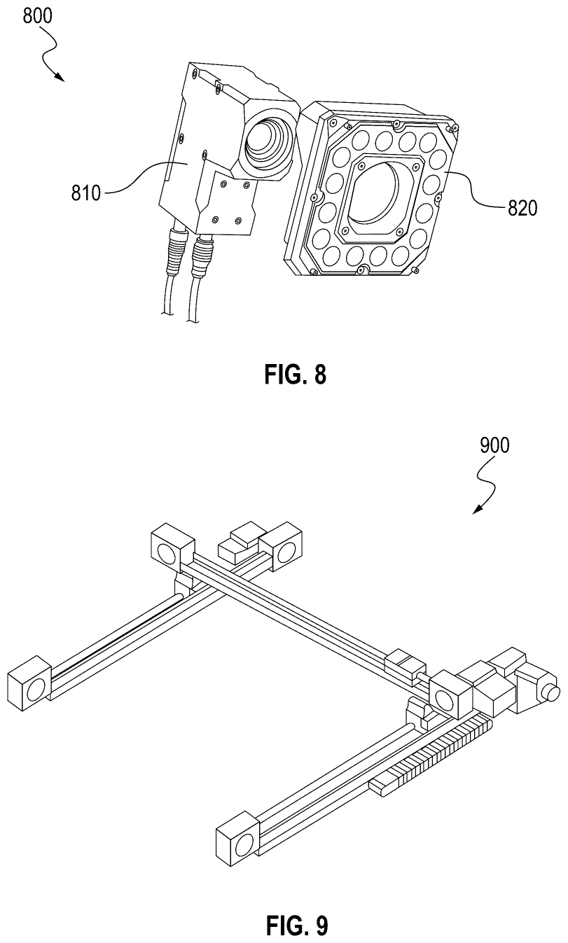

FIG. 8 presents a perspective view of an optical system 800 as may be used for capturing images for the testing systems 400, 500 of FIGS. 4A and 4B. In this arrangement, the optical system 800 represents a high-speed camera 810 and a so-called flash 820. The high-speed camera 810 and the flash 820 are separate components.

The optical system 800 may be programmed to measure and report a height of a bottom of a ball, such as ball 470, after contact with and rebound from a sports paddle by imaging and processing the ball's motion, eliminating the need to watch a video to determine the rebound height of the ball.

FIG. 9 is a representative x-y frame 900 as may serve as a part of the positioning device of FIG. 4B. Stated another way, the x-y frame 900 may be secured to the platform 415 or to secure clamps. The clamp 910 will be attached to the x-y frame 900 so that the paddle 300 can be precisely moved to any desired x-y coordinate. The x-y frame 900 can be adjusted so that the dropped ball 470 can strike the blade 330 in any location, or coordinate.

As can be seen, systems 400, 500 allow for the testing of sports paddles (primarily pickleball paddles such as paddles 100, 200, 300) to scientifically determine how well a ball 470 bounces off of the different areas of the paddle's playing surface 332. From systems 400, 500, a method of evaluating the response of a sports paddle is provided.

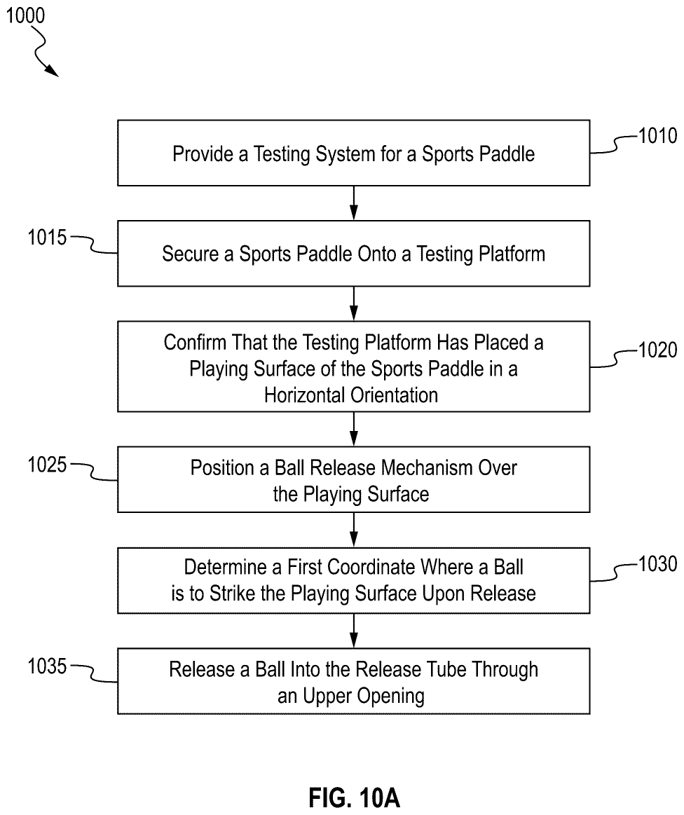

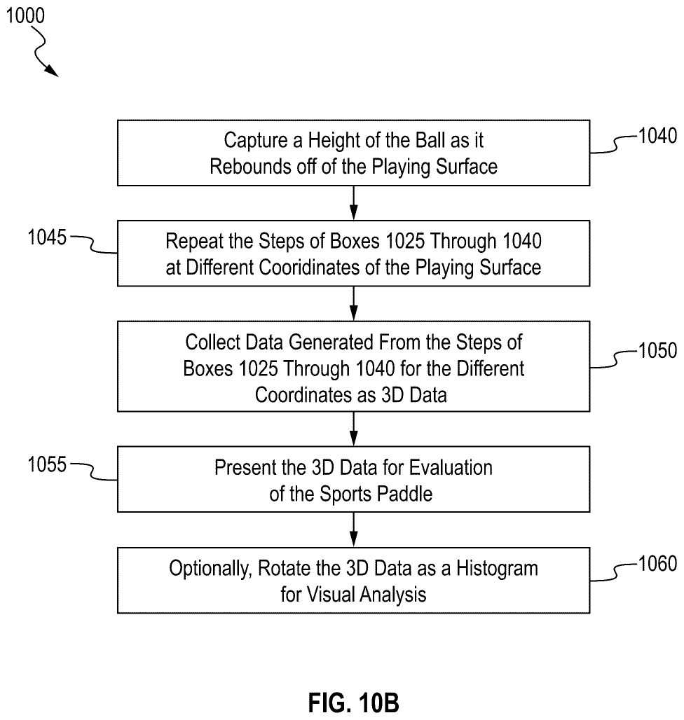

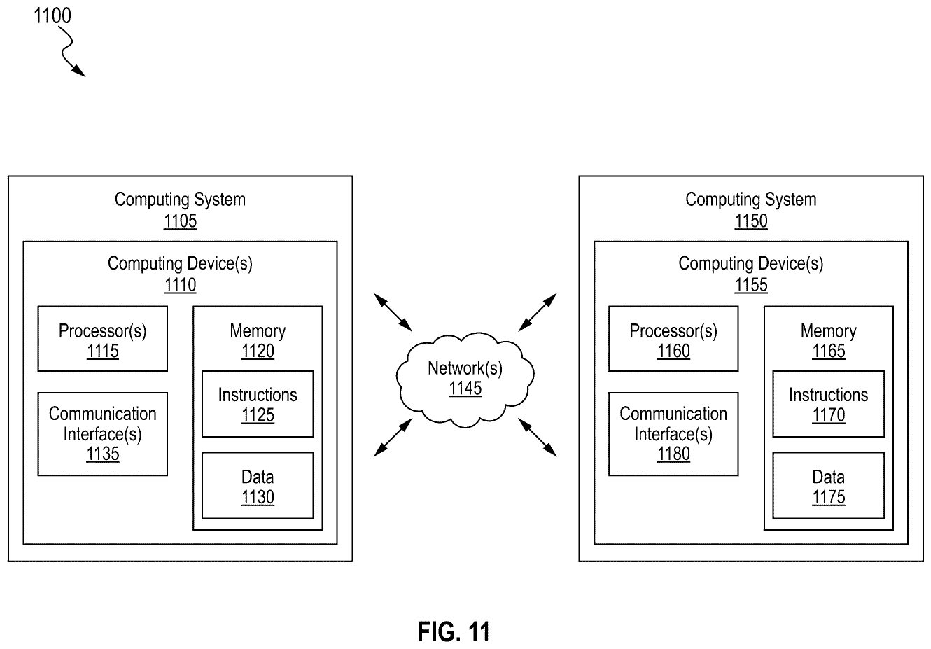

FIGS. 10A and 10B together present a single flow chart showing steps for performing a method 1000 of testing response of a ball off of a sports paddle, in one embodiment.

The method 1000 first comprises providing a testing system for a sports paddle. This is shown in Box 1010 of FIG. 10A. The paddle testing system may be in accordance with systems 400, 500 described above in their various embodiments.

The method 1000 next includes securing the sports paddle onto a testing platform. This is provided in Box 1015.

The method 1000 also comprises confirming that the testing platform has placed a playing surface of the sports paddle in a horizontal orientation. This is seen at Box 1020.

The method 1000 further includes positioning a ball release mechanism over the playing surface of the sports paddle. This is indicated at Box 1025. Preferably, the ball release mechanism is a release tube having an upper opening and a lower opening. In this instance, the step of Box 1025 will include ensuring that the release tube is positioned in a perfectly vertical orientation. Alternatively, the ball release mechanism is a mechanism designed to apply a force to a pickleball in order to launch it against a playing surface of a paddle.

In connection with the step of Box 1025, an operator will select a location, or coordinate, on the playing surface where the ball is to strike the paddle. This is seen at Box 1030 of FIG. 10A. Stated differently, the operator will determine a first coordinate where the ball is to strike the playing surface upon release from the ball release mechanism.

The method 1000 also includes releasing a ball into the release tube through the upper opening. This is shown at Box 1035 of FIG. 10A. In this step, the ball will pass through the upper opening, down through the tube itself, out of the lower opening, and onto the playing surface of the sports paddle. The ball will strike the playing surface at a predetermined x-y coordinate.

The method 1000 further comprises capturing a height of the ball as it rebounds off of the playing surface of the sports paddle. This is shown at Box 1040 of FIG. 10B. This capturing step may include the use of a high-speed camera to take a video of the path of the ball. Determining the maximum height of the rebound may be done manually (or visually) by carefully watching the video of the path of the ball. Alternatively, determining the maximum height of the rebound may be done through software, using the high-speed camera, and a flash.

In an alternative step, and as noted above, the high-speed camera may measure speed of the ball as it rebounds off of the playing surface of the pickleball paddle.

The method 1000 also includes repeating the steps of Boxes 1025 through 1040, wherein the release tube is positioned over the playing surface of the paddle at different x-y coordinates, or wherein a firing mechanism launches a pickleball at different locations along the playing surface of a paddle. This is provided in Box 1045. The rebound response data generated from Box 1045 is collected and then presented in a usable form. This is shown in Box 1050. Stated differently, the collected data generated from the steps of Boxes 1025 through 1040 for the different x-y coordinates are collected and presented as 3-D data. The collected data may be presented in the form of a table or chart. More preferably, this is in the form of a 3-D histogram such as is shown at 600A of FIGS. 6A and 6B.

The method 1000 additionally comprises presenting the 3-D data. This is shown at Box 1055. The 3-D data may be presented to a testing service such as testers associated with the USAPA. Alternatively, the 3-D data may be presented to a manufacturer of pickleball paddles. In this way, the manufacturer can consider the responsiveness of their paddles and how they might be improved. They can also compare the responsiveness of their paddles with those of their competitors.

Alternatively still, the 3-D data may be presented to a player at a paddle sport tournament, or to a player that is considering which paddle to purchase.

Finally, the method 1000 may optionally include rotating the 3-D data in order to acquire a fuller appreciation for the response of the ball off of the tested paddle. This is provided at Box 1060 of FIG. 10B. Each manufacturer may use the histograms of the 3-D data (under license of course) to demonstrate the response of their respective paddle products.

From the method 1000, it can be determined how a particular paddle performs under standardized testing. More importantly, a variety of paddles can be objectively evaluated, and then compared or rated to determine which paddle offers the most power, the most consistent response across its playing surface, or the most control.

Many factors affect the outcome of a shot. Some factors include the speed of the paddle's blade at impact, the angle of the paddle's blade, how firmly the player is squeezing the handle (grip strength), the speed of the ball toward the blade before it hits the blade, and the responsiveness of the paddle's blade. The responsiveness of the paddle's blade is different depending on where on the blade surface the ball hits.

It is observed that a typical swing causes a pickleball paddle to move along an arcuate trajectory. When this occurs, the end of the paddle is traveling faster than the handle. Therefore, a ball struck at the end of the paddle will have more force applied to it than a ball struck nearer to the handle. More force means it will bounce higher or rebound faster.

The equation used to calculate linear speed of a rotating object is:

$$V = ( 2 * π * r ) / T ;$$

where: V is the linear velocity;
   π is 3.14159;
   r is the radius of the object's motion; and
   T is the time it would take to complete a full 360 degree revolution.

In order to calculate velocity V, we can assume that r=22″. This is an assumed distance from a player's elbow to the center of the playing surface. Hitting a ball at 22″ will be multiplied by 1. Hitting a ball farther than the center will be multiplied by more than 1 to represent the higher speed. Hitting the ball closer than the center will be multiplied by less than 1.

Knowing r=22″ and wanting V to be 1, we can calculate T to be:

$$V = ( 2 * π * r ) / T$$

$$1 = ( 2 * π * 22 ” ) / T$$

$$\begin{matrix}T = ( 2 * π * 22 ” ) \\ = 138.23\end{matrix} .$$

Now that we know “T” to scale a hit in the center of the paddle, here is the equation for all data:

$$V = ( 2 * π * r ) / 138.23 , or$$

$$V = \text{.04545} * r .$$

If a ball is hit nearer to the grip than to the center, we might say that r=18″. In this case:

$$\begin{matrix}V = \text{.04545} * 18 \\ = 0.82\end{matrix}$$

This is 82% of the center. Thus, if the ball were to bounce close to the grip, this would be a height of 8.2″, which is 82% of 10″.

If a ball is hit at the center of the paddle, we would say that r=22″. In this case:

$$\begin{matrix}V = \text{.04545} * 22 \\ = 1.\end{matrix}$$

This is 100% in the center. Thus, if the ball were to bounce at 10″, the new data would still show 10″.

Finally, if a ball is hit at the end of the paddle, we might say that this is 4″ from the center. Here, r=26″. In this case:

$$\begin{matrix}V = \text{.04545} * 26 \\ = 1.18\end{matrix}$$

This is 118% of the center. So if the ball were to bounce farther from the grip to a height of 10″, the new data would show this height at 11.8″.

Pickleball players will want the sweet spot to be in the center of the paddle 300 (x and y), and not near the handle 310 or near the edge (head) guard 335. An ideal paddle would have a somewhat flat response; maybe slightly weaker at the distal (second) end 104 than the proximal (first) end 102.

It is observed that some players may prefer a paddle that offers a softer response, while others prefer a paddle that offers greater power. Paddle retailers can promote their paddles based on the objective measurements of the histograms.

Almost all manufacturers use the words “sweet spot” to define an area that is said to hit the ball with the most power and consistency. There is no clear definition of a “sweet spot,” and even if there was, it is inadequate to describe how different paddles have accomplished making their paddles more consistent across the entire hitting face. Therefore, the 3-D data is advantageous and beneficial for objectively determining the responsiveness of a pickleball paddle.

It is noted that as part of the presenting step of Box 1055, the 3-D data may be sent from one computing system to another computing system. In one aspect, as 3-D data is gathered for the different paddles, a library of data can be created for the variety of paddles. In this aspect, a computer will store the data and send it to other computers in a network.

FIG. 11 is a schematic diagram of a computing system 1100 that can be used to implement the step of Box 1055 of FIG. 10B, and in particular for delivering the 3-D data collected for different paddles to other users. The exemplary system 1100 includes a computing system 1105 and a computing system 1150 that are communicatively coupled over a network 1145.

The computing system 1105 can include one or more computing devices 1110, but preferably represents a mobile computing device such as an iPhone® or an iPad® having a camera. Alternatively, the mobile computing device 1105 will be electrically connected to a separate high-speed camera, where images are first captured.

The computing device(s) 1110 of the computing system 1105 includes a processor 1115 and memory 1120. The processor 1115 can be any suitable processing device (e.g., a processor core, a microprocessor, an ASIC, a FPGA, a controller, or a microcontroller) and can be one processor or a plurality of processors that are operatively connected. The memory 1120 can include one or more non-transitory computer-readable storage media, such as RAM, ROM, EEPROM, EPROM, one or more memory devices, flash memory devices, and combinations thereof.

The memory 1120 can store information that can be accessed by the processor 1115. For instance, the memory 1120 can include computer-readable instructions 1125 that can be executed by the processor 1115. The instructions 1125 can be software written in any suitable programming language or can be implemented in hardware. Additionally, or alternatively, the instructions 1125 can be executed in logically and/or virtually separate threads on the processor 1115. For example, the memory 1120 can store instructions 1125 that when executed by the processor 1115 cause the processor 1115 to perform operations such as any of the operations and functions for which the computing systems 1105, 1150 are configured, as described herein.

The memory 1120 can store data 1130 that can be obtained, received, accessed, written, manipulated, created, and/or stored. The data 1130 can include, for instance, the types of paddles evaluated, the specifications of the paddles tested, the dates of testing, ambient conditions in which paddle testing took place, and the 3-D data as described herein. In some implementations, the computing device 1110 can obtain from and store data in one or more memory device(s) that are remote from the computing system 1105 such as one or more memory devices of the computing system 1150.

The computing device 1110 can also include a communication interface 1135 used to communicate with one or more other systems (e.g., computing system 1150). The communication interface 1135 can include any circuits, components, or software for communicating via one or more networks 1145. In some implementations, the communication interface 1135 can include one or more of a communications controller, receiver, transceiver, transmitter, software, and/or hardware for communicating data.

The computing system 1150 can include one or more computing devices 1155. The computing devices 1155 can include one or more processors 1160 and a memory 1165. The processors 1160 may be any suitable processing device such as a processor core, a microprocessor, an ASIC, a FPGA, a controller, or a microcontroller, and can be one processor or a plurality of processors that are operatively connected. The memory 1165 can include one or more non-transitory computer-readable storage media, such as RAM, ROM, EEPROM, EPROM, one or more memory devices, flash memory devices, or combinations thereof.

The memory 1165 can store information that can be accessed by the one or more processors 1160. For instance, the memory 1165 (e.g., one or more non-transitory computer-readable storage mediums, memory devices) can store data 1175 that can be obtained, received, accessed, written, manipulated, created, and/or stored. The data 1175 can include the 3-D data generated in connection with the method 1000. The computing system 1150 may obtain data from one or more memory device(s) that are remote from the computing system 1150.

The memory 1165 can also store computer-readable instructions 1170 that can be executed by the one or more processors 1160. The instructions 1170 can be software written in any suitable programming language or can be implemented in hardware. Additionally, or alternatively, the instructions 1170 can be executed in logically and/or virtually separate threads on the processor 1160. For example, the memory 1165 can store instructions 1170 that when executed by the processor 1160 cause the processor 1160 to perform any of the operations and/or functions described herein.

The computing device(s) 1155 can also include a communication interface 1180 used to communicate with one or more other systems. The communication interface 1180 can include any circuits, components, or software for communicating via one or more networks (e.g., 1145). In some implementations, the communication interface 1180 can include one or more of a communications controller, receiver, transceiver, transmitter, port, conductors, software, and/or hardware for communicating data.

The network 1145 can be any type of network or combination of networks that allows for communication between devices. In some embodiments, the network 1145 can include one or more of a local area network, wide area network, the Internet, secure network, cellular network, mesh network, peer-to-peer communication link, and/or some combination thereof and can include any number of wired or wireless links.

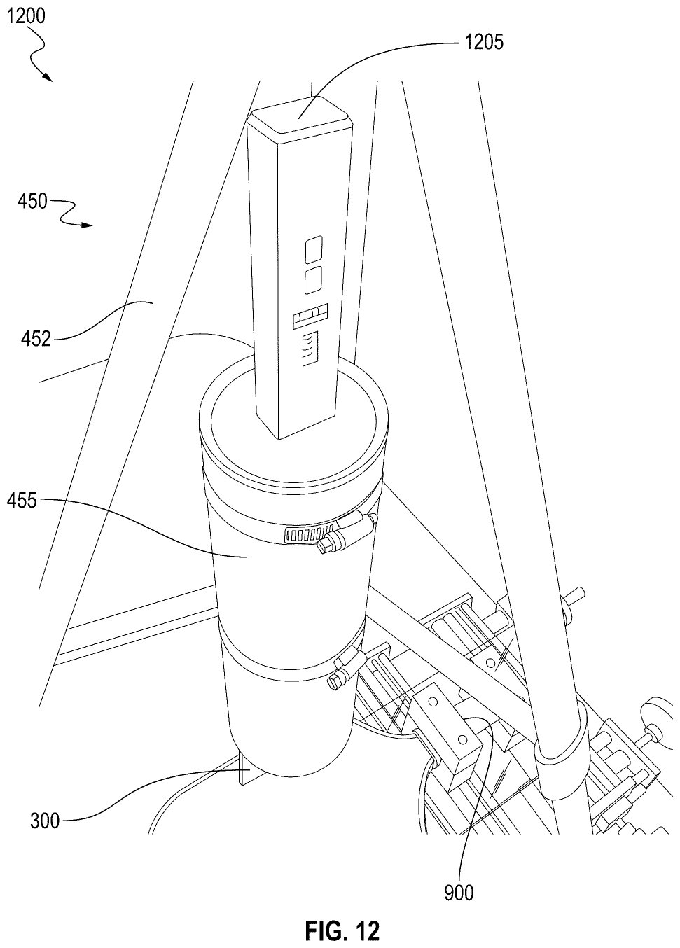

FIG. 12 is a perspective view of a portion of a system 1200 used for evaluating a response of a ball, such as ball 470, upon impact with a sports paddle, such as paddles 100, 200, 300, in an alternate embodiment. In this view, the paddle 300 is held in its horizontal orientation by the sliding x-y frame 900.

The testing system 1200 includes a launch mechanism 450. The launch mechanism 450 is designed to ensure that the ball, such as ball 470 of FIG. 5B, is launched from a consistent height, and falls in a perfectly vertical direction. The illustrative launch mechanism 450 includes a stand 452. The launch mechanism 450 also has a release tube 455. The release tube 455 is secured to the stand 452 to ensure consistency in testing.

Of interest, system 1200 utilizes an electronic laser level 1205. The level 1205 is used to ensure that the ball release tube 455 is vertical when a ball is released onto the paddle 300. The level 1205 may be used to ensure that the release tube 455 is secured to the stand 452 in a perfectly vertical manner, that is, along a “z” plane. In addition, the laser level 1205 may be used to see where on the paddle the dropped ball will hit. The laser level 1205 is removed before the ball 470 is actually dropped.

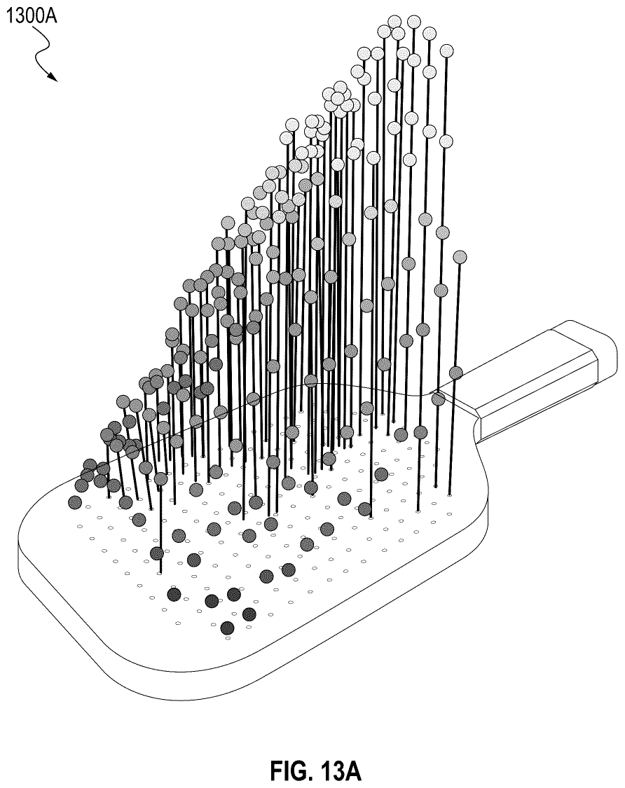

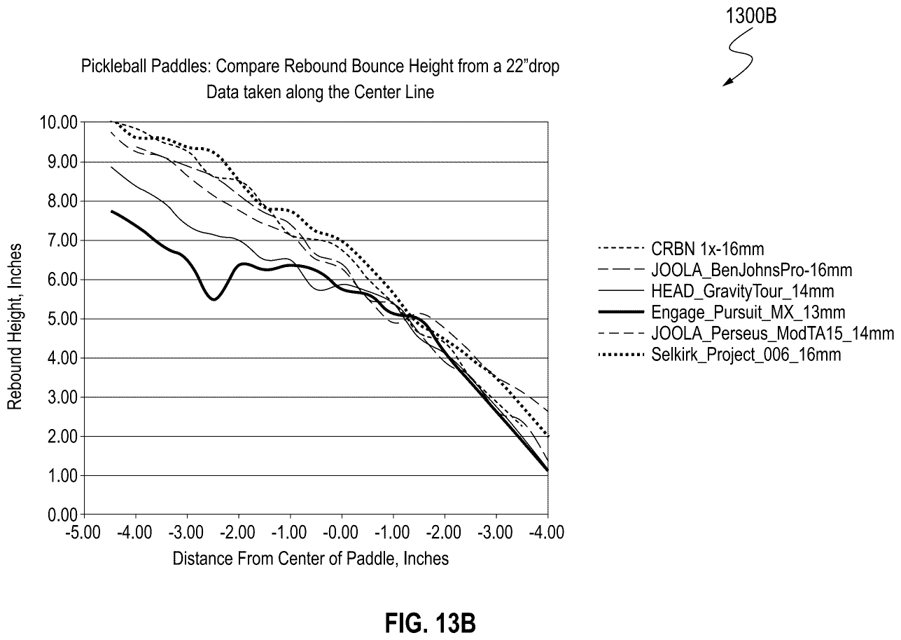

FIG. 13A is a computer-generated view of a first histogram 1300A showing the response of a ball relative to a pickleball paddle, in an alternate embodiment. The histogram shows 3-D data.

FIG. 13B is a second histogram 1300B wherein the responsiveness of a plurality of paddles is shown together. In this view, the histogram 1300B shows 2-D data. The histogram 1300B allows the user to compare several paddles in a single graph.

The particular embodiments disclosed above are illustrative only, as the embodiments may be modified and practiced in different but equivalent manners apparent to those skilled in the art having the benefit of the teachings provided herein. It is therefore evident that the particular embodiments disclosed above may be altered and/or modified, and all such variations are considered within the scope and spirit of the present application. For example, the testing system may be used for testing responsiveness of padel paddles, racquetball paddles, squash racquets, or even tennis racquets.

In the claims which follow, the word “comprising” is used in its inclusive sense and does not exclude other elements being present. The indefinite articles “a” and “an” before a claim feature do not exclude more than one of the features from being present. Each one of the individual features described herein may be used in one or more embodiments and are not, by virtue of only being described herein, to be construed as essential to all embodiments as defined by the claims.

I claim:

1. A system for testing a sports paddle, wherein the sports paddle has a handle and a playing surface, and the system comprises:
a platform;
a securing mechanism for holding the sports paddle onto the platform;
a ball release mechanism configured to release a ball onto the playing surface at a selected coordinate on the playing surface; and
a ball detection device configured to record a path of the ball upon release from the ball release mechanism after impact with the sports paddle.

2. The system of claim 1, wherein:
the securing mechanism comprises a clamp configured to secure the handle of the sports paddle onto the platform; and
the system further comprises a support stand for supporting the ball release mechanism.

3. The system of claim 2, wherein the ball release mechanism comprises:
an elongated tube having an upper opening and a lower opening; and
a clamp for connecting the elongated tube to the support stand.

4. The system of claim 3, wherein the ball release mechanism is configured to allow a user to change the selected coordinate on the playing surface.

5. The system of claim 2, wherein the ball release comprises a compressed air launcher, a rotational wheel launcher, or a servo-actuated arm.

6. The system of claim 1, wherein:
the ball is a ball used for playing pickleball; and
the sports paddle is a pickleball paddle.

7. The system of claim 6, wherein the ball detection device:
is a high-speed camera, a laser, or a radar gun; and
is configured to also record the path of the ball before impact with the sport paddle.

8. A method for testing a sports paddle, comprising:
(1) providing a testing system for the sports paddle;
(2) determining a height of a release tube;
(3) securing a first sports paddle to a testing platform such that a playing surface of the sports paddle is in a horizontal orientation below the release tube;
(4) securing the release tube to a support stand such that the release tube is in a vertical orientation;
(5) selecting a first coordinate on the playing surface of the first sports paddle;
(6) releasing a ball into the release tube such that the ball travels through an upper opening, through the release tube, through a lower opening, and onto the selected coordinate on the playing surface; and
(7) measuring a response of the ball at the selected coordinate in terms of height.

9. The method of claim 8, further comprising:
(8) repeating steps (3) through (7) at a plurality of additional coordinates on the playing surface.

10. The method of claim 9, further comprising:
(9) collecting and storing data generated from steps (7) and (8) as 2-D data or as 3-D data in a memory of a first computing system.

11. The method of claim 10, wherein the 2-D data or the 3-D data comprises data selected from the group consisting of a type of paddle tested, specifications of the paddle tested, a date of testing, ambient conditions in which paddle testing occurred, the height of the release tube, and combinations thereof.

12. The method of claim 11, further comprising:
(10) securing a second sports paddle to the testing platform such that a playing surface of the second sports paddle is in a horizontal orientation below the release tube; and
(11) repeating steps (4) through (9) for the second sports paddle.

13. The method of claim 12, further comprising:
using a wireless network, transmitting the 2-D data or the 3-D data to a second computing system.

14. The method of claim 12, further comprising:
presenting the 2-D data or the 3-D data to (i) a manufacturer of pickleball paddles, (ii) a pickleball player, or (iii) both.

15. A computer-implemented method of testing a sports paddle, comprising:
obtaining, by a computing system comprising a computing device and a camera, a photograph of a ball relative to a playing surface of the sports paddle after the ball has struck the playing surface at a first coordinate;
obtaining, by the computing system, a photograph of the ball relative to the playing surface of the sports paddle after the ball has struck the playing surface at a plurality of additional coordinates;
determining, by the computing system, a height at which the ball has bounced after striking the playing surface of the sports paddle for each of the first coordinate and the plurality of additional coordinates; and
providing for display, by the computing system via one or more display devices, a three-dimensional plot showing the heights of the ball response relative to the playing surface of the sports paddle.

16. The method of claim 15, wherein the camera is a high-speed camera configured to capture a plurality of image frames of the ball during its rebound from the playing surface, and wherein the computing system determines the height at which the ball has bounced after striking the playing surface for each of the first coordinate and the plurality of additional coordinates.

17. The method of claim 16, further comprising:
storing, in a memory of the computing system, the heights determined for the first coordinate and the plurality of additional coordinates as 2-D data or as 3-D data (“Data”) together with associated metadata comprising at least one of a paddle identifier, paddle specifications, a date and time of testing, and ambient test conditions; and
transmitting the Data and associated metadata to a remote computing system over a wireless network.

18. The method of claim 16, further comprising:
automatically triggering high-speed image capture by the camera when the ball exits a release tube; and
using the images to compute an apex height of the ball.

19. The method of claim 18, wherein the camera images a measuring device having marked heights, and the computing system reads the marked heights to determine the apex height of the ball.

20. The method of claim 17, further comprising:
confirming the playing surface is oriented horizontally;
confirming the release tube is oriented vertically;
positioning the release tube at a predetermined height above the playing surface; and
selecting coordinates by moving either the release tube or the paddle within an x-y frame.

21. The method of claim 17, further comprising:
generating one or more performance metrics from the Data;
storing the Data and the performance metrics in a paddle library;
comparing the Data or performance metrics of two or more paddles; and
outputting a report or visual comparison to a manufacturer, testing service, or player.

22. A computer-implemented method of testing a sports paddle, comprising:
(a) obtaining, by a computing system comprising a computing device and a speed detection device, a speed of a pickleball prior to hitting a playing surface of a pickleball paddle at a first coordinate;
(b) obtaining, by the computing system, a speed of the pickleball after striking the surface of the sports paddle at the first coordinate;
(c) repeating steps (a) and (b) at a second coordinate on the playing surface of the pickleball paddle; and
providing for display, by the computing system via one or more display devices, a plot showing the speed of the ball after striking the playing surface of the pickleball paddle at the first and second coordinates.

23. The computer-implemented method of claim 22, wherein the speed detection device is a camera, a laser, or a radar gun.
